(19) United States
(12) Patent Application Publication
(10) Pub. No.: US 2019/0329208 A1
(43) Pub. Date: Oct. 31, 2019

(54) PRODUCTION OF AEROGELS AND CARBON AEROGELS FROM LIGNIN

(71) Applicant: DOMTAR PAPER COMPANY, LLC, Fort Mill, SC (US)

(72) Inventors: Shabnam SANAEI, Montreal (CA); Bruno MARCOCCIA, Fort Mill, SC (US); Frank K. KO, Vancouver (CA); Scott RENNECKAR, Vancouver (CA); Muzaffer A. KARAASLAN, Vancouver (CA)

(21) Appl. No.: 16/469,351

(22) PCT Filed: Dec. 13, 2017
(86) PCT No.: PCT/US2017/066193

§ 371 Date: Jun. 13, 2019

Related U.S. Application Data
(60) Provisional application No. 62/433,536, filed on Dec. 13, 2016.

(51) Int. Cl. B01J 13/00; C01B 32/15

(52) U.S. Cl. CPC B01J 13/0091; C08L 97/005; C01B 32/15

(57) ABSTRACT

A method for producing high-purity lignin based aerogels and carbon aerogels having improved physical and operational properties. Such high-purity lignin based carbon aerogels can be formaldehyde free and can be used for a wide range of applications including supercapacitor electrodes for supercapacitor cells.

### CROSS-REFERENCE TO RELATED APPLICATION

This application claims the benefit of U.S. Provisional Application No. 62/433,536, filed Dec. 13, 2016, which application is incorporated herein in its entirety.

### FIELD OF THE INVENTION

The present invention relates generally to the conversion of lignin to an advanced material and particularly to the conversion of lignin to aerogels and to their carbon derivatives.

### BACKGROUND

For many applications where both a high surface area and electrical conductivity are required, it is desirable to have a monolithic material that is electrically conductive. One such desirable material is carbon aerogel. At the nanoscale, carbon aerogels are composed of nanoparticles of carbon with diameters approximately 1-2 nm. Like other aerogels, carbon aerogels are primarily mesoporous with a mean pore diameter of approximately 7-10 nm and a surface area ranging from 500-800 m² g⁻¹. However, the mean pore diameter and the surface area of a carbon aerogel are highly dependent on density and whether or not other materials or additives have been introduced (intentionally or unintentionally) into the aerogel. Conventionally, it is known that the surface area of a carbon aerogel can be increased post-production by placing it under a flow of steam or hydrogen at elevated temperatures (400° C.-1000° C.). At these temperatures, water and hydrogen will react with carbon in the aerogel to form gaseous products and resultantly form micropores (pores<2-3 nm in diameter) throughout the interior of the aerogel, thereby increasing the surface area up to 2,500 m² g⁻¹.

Currently most carbon aerogels are made of carbon nanotubes or graphene through a catalyst-assisted chemical vapor deposition method. Biomass based organic aerogels and carbon aerogels, featuring low cost, high scalability and small environmental footprint, represent a new direction in aerogel development. Lignin and cellulose, two of the most abundant natural polymers in the world, are promising low cost renewable raw materials for prospective value-added products, such as carbon aerogels.

Current methods for producing carbon aerogel include using resorcinol and formaldehyde or phenol and formaldehyde as starting materials. In these methods, resorcinol and formaldehyde may be reacted in the presence of a basic catalyst, and the subsequent product can be supercritically dried in carbon dioxide to produce an aerogel, which can be an organic or inorganic aerogel. The aerogel can then be pyrolyzed under high temperatures in the presence of an inert gas to produce carbon aerogel. One of the disadvantages of this method is the need for a basic catalyst. If the catalyst concentration is relatively high, the gel may undergo significant contraction during both supercritical drying and carbonization, thereby increasing the difficulty in obtaining carbon aerogel having a low weight density. On the other hand, if the catalyst concentration is relatively low, the carbon aerogel may not be formed. In addition, the methods are complicated and expensive to perform, and difficult to control, particularly on a large scale. The methods also typically require a long preparation time and involves expensive starting materials.

One conventional method to form a non-carbonized lignin based aerogel includes reacting lignin, resorcinol and formaldehyde using sodium carbonate as the catalyst. While it is known that resorcinol reacts easily with formaldehyde compared to lignin and phenol, generally a maximum 50% by weight of resorcinol can be substituted by lignin to form these exemplary non-carbonized lignin based aerogels. Also, the amount of formaldehyde used in these types of LRF (lignin, resorcinol, formaldehyde) non-carbonized aerogels is significantly higher than that used in LPF (lignin, phenol, formaldehyde) non-carbonized aerogels. Formaldehyde, however, is a toxic and carcinogenic substance and recent toxicology regulations in North America and Europe suggest limiting the use of formaldehyde. In another method to form a non-carbonized lignin based aerogel, lignin, phenol and formaldehyde (with a maximum 80% by weight of phenol being substituted by lignin) are reacted under alkaline conditions using a sodium hydroxide (NaOH) catalyst. The non-carbonized lignin based aerogels described above are not electrically conductive and are therefore not suitable for energy storage and/or supercapacitor applications.

It is also known to produce nanocomposite carbon lignin based aerogels that are mainly comprised of bacterial cellulose (˜75 wt. %) and LRF (˜25 wt. %). In the production of the nanocomposite carbon lignin based aerogel, an alkali lignin solution is mixed with resorcinol and formaldehyde to form a LRF solution and then bacterial cellulose gel cubes are subsequently impregnated with the LRF solution. After gelation, supercritical drying and carbonization, the nanocomposite carbon aerogels are formed, with LRF carbon nano-aggregates decorating the surface of bacterial cellulose carbon nanofibers. These nanocomposite carbon aerogels have a BET surface area, measured using the conventional Brunauer, Emmett and Teller method, up to 250 m²/g, a bulk density of about 0.026 g/cm³, and a low volumetric capacitance (F/cc).

It is desirable for the lignin-based carbon aerogel to have an increased volumetric capacitance. This property makes them suitable candidates for flexible solid-state energy storage devices.

Besides energy storage, the conductive interconnected nanoporous structure can also find applications in oil/water separation, catalyst supports, sensors, thermal insulation, etc.

It is desirable to produce lignin based carbon aerogels having improved physical and operational properties to expand their potential applications. It will be desirable to provide methods and systems for producing carbon aerogels that can at least ameliorate the high costs and low yields obtained from the current methods of producing carbon aerogel.

### SUMMARY

Described herein are methods for producing high-purity lignin based carbon aerogels having improved physical and operational properties. Also described herein are supercapacitor cells formed with supercapacitor electrodes that can be formed from the high-purity lignin based carbon aerogels produced by the method described herein.

In one aspect, the high-purity lignin based carbon aerogels can be porous, amorphous, nano-carbon materials that have a three-dimensional interconnected porous structure. The average size and density of the pores in the formed high-purity lignin based carbon aerogels can be dimensioned on a nanometer scale. It is contemplated that the high-purity lignin based carbon aerogels can be formed, for example and without limitation, as a monolithic structure, as a composite, as a thin film, as a granular powder, and the like. As noted above, the conventional production of aerogels can be time and energy consuming and can lead to aerogels that can have decreased mechanical performance. It is contemplated that the formed high-purity lignin based carbon aerogels of the present invention can be easily integrated into other materials, including materials for special applications such as electrode materials for supercapacitor cells, energy storage devices, catalysts and the like.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a schematic flow diagram with accompanying photos illustrating a non-limiting example of a method of producing carbon aerogel from high-purity lignin.

FIG. 2 is a schematic flow diagram illustrating a non-limiting example of a method of producing carbon aerogel from high-purity lignin and showing a residence timeline comparison with respect to the formulation of conventional resorcinol-formaldehyde (RF) carbon aerogels.

FIG. 3 is a schematic flow diagram illustrating a non-limiting example of a method of producing an embodiment (BL-50) carbon aerogel from high-purity lignin.

FIG. 4 is a schematic flow diagram illustrating a non-limiting example of a method of producing an embodiment (BL-100) carbon aerogel from high-purity lignin.

FIG. 5 is a schematic flow diagram illustrating a non-limiting example of the energy expenditure used in the method of producing carbon aerogel from high-purity lignin that is schematically illustrated in FIG. 2.

FIG. 6 is a table showing experimental formulations for carbon aerogels produced from high-purity lignin (the BL samples) and control samples from phenol-formaldehyde (PF) and an additional control lignin source (Indulin AT) prepared under identical conditions.

FIGS. 7A-7C are SEM photographs of the exemplary morphology of the carbon aerogels produced from high-purity lignin in the method schematically illustrated in FIG. 12 with the use of phenol or formaldehyde additives.

FIG. 8 is a table showing the BET surface area (m²/g), pore volume (cm³/g), and average pore width (nm) of the experimental carbon aerogels produced from high-purity lignin and the control samples.

FIGS. 9A and 9B are comparison SEM photographs of the experimental carbon aerogels produced from lignin and the control lignin source (Indulin AT) prepared under identical conditions.

FIG. 10 is a schematic flow diagram illustrating a non-limiting example of a method of producing carbon aerogel from high-purity lignin without the use of phenol or formaldehyde additives.

FIG. 11 is a table showing experimental formulations for carbon aerogels produced from high-purity lignin samples produced in the method schematically illustrated in FIG. 2 and experimental formulations for carbon aerogels produced from high-purity lignin produced in the method schematically illustrated in FIG. 10 without the use of phenol or formaldehyde additives.

FIG. 12 is a chart illustrating the gel point determination for the experimental formulations for carbon aerogels produced from high-purity lignin produced in the method schematically illustrated in FIG. 10 without the use of phenol or formaldehyde additives.

FIG. 13 is a table showing experimental results of the gelation time requirements verses the epichlorohydin weight percentage for the experimental formulations for carbon aerogels produced from high-purity lignin produced in the method schematically illustrated in FIG. 10 without the use of phenol or formaldehyde additives.

FIGS. 14A-14B are SEM photographs of the exemplary morphology of the carbon aerogels produced in the method schematically illustrated in Fig. without the use of phenol or formaldehyde additives.

FIGS. 15A-15C are SEM photographs of comparisons of the exemplary morphology of the carbon aerogels produced in the methods schematically illustrated in FIGS. 2 and 10.

FIG. 16 is a schematic illustration of a supercapacitor electrode formed with a carbon aerogel produced by the methods provided herein.

FIG. 17 is a graph illustrating the cyclic voltammetry of the supercapacitor electrode shown in FIG. 16 for the experimental carbon aerogels produced by the methods provided herein.

FIG. 18 is a graph illustrating the constant current charge-discharge cycles of the supercapacitor electrode shown in FIG. 16 for the experimental carbon aerogels produced by the methods provided herein.

FIG. 19 is a table showing the gravimetric specific capacitance of the experimental carbon aerogels produced from high-purity lignin and the control samples.

FIG. 20 is a table showing the gravimetric capacitance (F/g), the volumetric (F/cm³), surface area (m²/g) and density (g/cm³) of the supercapacitor electrode shown in FIG. 16 for the experimental carbon aerogels produced from high-purity lignin and the control samples.

FIG. 21 is a table showing the comparison of the supercapacitor electrode shown in FIG. 16 for the experimental carbon aerogels produced from high-purity lignin and a conventional battery.

FIG. 22 is a Ragone chart that plots the storage device energy versus power density on a log-log coordinate system, with discharge times represented as diagonals.

FIG. 23 is a graph depicting gel formation of different lignin types with epichlorohdyrin at 70° C. to determine a gel point using a rheometer with 1% oscillatory strain at 1 Hz.

FIG. 24 are graphs showing the effect of the type of lignin on gel formation—with Epichlorohydrin at 70° C. (A) Time course for gelation of BioChoice lignin (BL), Glyoxalated lignin (BL-Gly). Low water soluble lignin pellets (BL-pel) reacted with epichlorohydrin at 70° C. (B) Bar graph of gelation time per lignin type.

FIG. 25 is a graph showing the effect of reaction pH on gel formation BL-Gly gelation with Epichlorohydrin at 70° C.

FIG. 26 is a graph of the effect of reaction pH and lignin type on gelation time (gelation with Epichlorohydrin at 70° C.).

FIG. 27 is a graph of the effect of reaction temperature on gelation time on gelation of BL-Gly with Epichlorohydrin.

FIG. 28 is a micrograph of the surface morphology of lignin aerogels with epichlorohdyrin (Scanning electron microscopy).

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various descriptions of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention.

As used throughout, the singular forms “a,” “an” and “the” include plural referents unless the context clearly dictates otherwise. Thus, for example, reference to “a conductor” can include two or more such conductors unless the context indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain embodiments

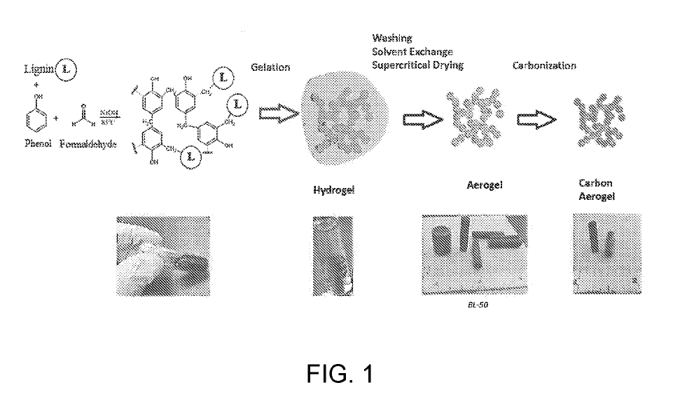

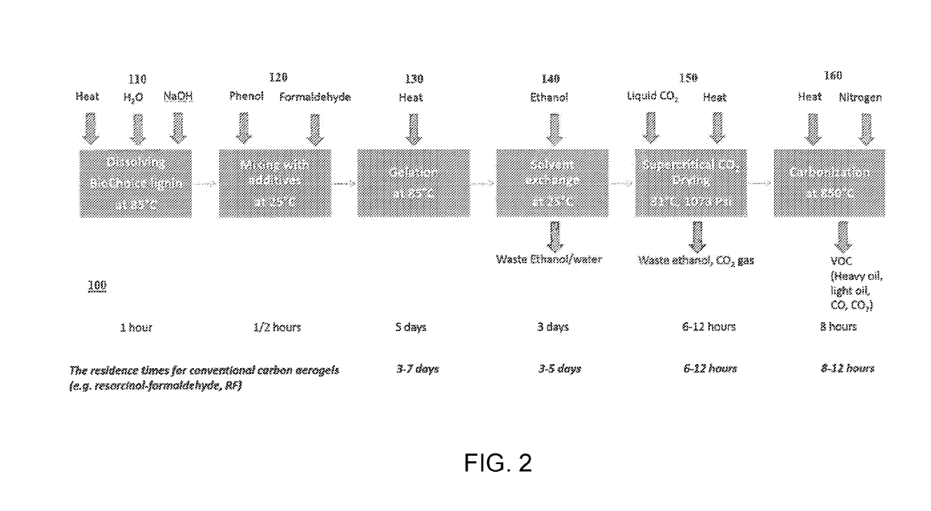

Disclosed herein are methods and systems for producing carbon aerogels having improved physical and operational properties. One embodiment of a method for producing carbon aerogel in accordance with the present disclosure is illustrated in the flow diagrams shown in FIGS. 1 and 2. As illustrated in FIG. 2, the method 100 can include one or more functions, operations, or actions as illustrated by one or more of operations 110-160. In FIG. 2, operations 110-160 are illustrated as being performed sequentially with operation 110 first and operation 160 last. It will be appreciated however that these operations can be combined and/or divided into additional or different operations as appropriate to suit particular optional embodiments. For example, additional operations can be added before, during or after one or more of operations 110-160. In some embodiments, one or more of the operations can be performed at or about the same time.

At operation 110, high-purity lignin can be dissolved in a solution that is heated to a desired first temperature and is held at that first temperature for a desired first dwell time so that the high-purity lignin can naturally crosslink through free radical reactions that cause the lignin chains to cleave and then to reform new bonds. In operation 110, the solution can comprise a mixture of water and sodium hydroxide (NaOH). The solution and the high-purity lignin can be heated to the first temperature of at least about 75° C., preferably at least about 80° C., and most preferred about 85° C. In another exemplary aspect, the preferred first temperature can be between about 75° C. to about 95° C. The preferred first dwell time at the first temperature can be at least about 30 minutes, preferably at least about 45 minutes, and most preferred about 60 minutes. Optionally, the preferred first dwell time at the first temperature can between about 30 minutes to about 90 minutes, and preferably between about 30 minutes to about 60 minutes.

In one example, the high-purity lignin can be hardwood and/or softwood lignin having an impurity level of between about 0.02 to about 5.00 weight percent, preferably between about 0.05 and about 3 weight percent, and more preferred between about 0.10 and about 1 weight percent. Optionally, the high-purity lignin can be hardwood or softwood lignin having an impurity level between about 0.15 to about 0.70 weight percent, preferably between about 0.175 and about 0.50 weight percent, and more preferred between about 0.20 to about 0.30 weight percent. It is also contemplated that the high-purity lignin can be a softwood lignin having an impurity level of less than 0.3, which provides a mixture of guaiacyl and syringyl units that provide additional crosslinking points.

The high-purity lignin can also have a sulfur content of less than 5 weight percent, preferably less than 4 weight percent, and more preferred less than 3 weight percent. Optionally, the high-purity lignin can have a low sulfur content of between about 2 to about 3 weight percent. It is also contemplated that the high-purity lignin can have a sodium content of less than 1.5 weight percent, preferably less than 0.9 weight percent, and more preferred less than 0.8 weight percent. In one optional aspect, the high-purity lignin can have a low sulfur content of between about 0.2 to about 0.8 weight percent. In one example, and not meant to be limiting, a suitable exemplary high-purity lignin can comprise DOMTAR Biochoice™ lignin. Optionally, it is contemplated that a suitable high-purity lignin can comprise high water soluble lignin powder, low water soluble lignin pellets or granules or glyoxalated lignin.

In operation 120, at least one additive is added to the dissolved mixture exiting operation 110. In this embodiment, it is contemplated that the at least one additive can comprise phenol and formaldehyde. It is desired that the formed mixture in operation 120 can be held at a second temperature for a desired second dwell time. The second temperature can be at least about 15° C., preferably at least about 20° C., and most preferred about 25° C. Optionally, the preferred second temperature can be between about 20° C. to about 30° C. The second dwell time at the second temperature can be at least about 20 minutes, preferably at least about 30 minutes, and most preferred about 40 minutes. In another exemplary aspect, the second dwell time in operation 120 can be between about 20 minutes to about 40 minutes, and preferably between about 25 minutes to about 35 minutes.

Subsequently, in operation 130, the mixture exiting operation 120 can be held at a third temperature for a desired third dwell time to allow for the gelation illustrated in FIG. 1 to occur. In operation 130, the mixture can be heated to the third temperature of at least of at least about 75° C., preferably at least about 80° C., and most preferred about 85° C. Optionally, the third temperature can be between about 75° C. to about 95° C. The third dwell time in operation 130 can be at least about 3 days, preferably at least about 4 days, and most preferred about 5 days. Optionally, the preferred third dwell time can be between about 3 days to about 6 days, and preferably between about 3 days to about 5 days.

Next, in operation 140, at least one solvent can be added to the formed hydrogel produced in operation 130 so that waste materials can be removed during the course of operation 140. For example and without limitation, the at least one solvent that can be added to the formed hydrogel can comprise ethanol, and the removed waste materials can comprise water and ethanol. After adding the at least one solvent, the formed mixture in operation 140 can be processed at a desired fourth temperature for a desired fourth dwell time. In this operational step, the fourth temperature can be at least about 15° C., preferably at least about 20° C., and most preferred about 25° C. Optionally, the preferred fourth temperature can be between about 20° C. to about 30° C. The preferred forth dwell time within operation 140 is at least about 1 days, preferably at least about 2 days, and most preferred about 3 days. It is also contemplated that the preferred fourth dwell time can be between about 1 days to about 4 days, and preferably between about 2 days to about 3 days.

In operation 150, liquid carbon dioxide (CO₂) can be added to the product emerging from operation 140 to effect supercritical drying. In the course of this operational step, the mixture in operation 150 can be held at a fifth temperature under a desired pressure for a desired fifth dwell time. The formed mixture in operation 150 can be heated to the fifth temperature of at least about 25° C., preferably at least about 30° C., and most preferred about 35° C. In another exemplary aspect, the preferred fifth temperature can be between about 29° C. to about 33° C. The preferred fifth dwell time in operation 150 can be at least about 4 hours, preferably at least about 5 hours, and most preferred about 6 hours. Optionally, the preferred fifth dwell time can be between about 4 hours to about 15 hours, and preferably between about 6 hours to about 12 hours. The desired pressure in operation 150 can be at least between about 750 psi to about 1500 psi, preferably between about 1000 psi to about 1100 psi, and most preferred between about 1050 psi to about 1080 psi.

Finally, in operation 160, nitrogen can be added to the mixture exiting operation 150 to allow for the slow pyrolysis of the mixture which carbonizes the formed product. In this operational step, the resultant mixture can be held at a desired sixth temperature for a desired sixth dwell time after the nitrogen is added. The sixth temperature can be at least about 800° C., preferably at least about 825° C., and most preferred about 850° C. The sixth temperature can optionally be between about 800° C. to about 900° C. Similarly, the preferred sixth dwell time in operation 160 can be at least about 6 hours, preferably at least about 7 hours, and most preferred about 8 hours. The sixth dwell time can optionally be between about 6 hours to about 10 hours, and preferably between about 7 hours to about 9 hours. It is contemplated that waste materials can comprise at least one of: char, carbon monoxide, carbon dioxide gas, pyrolysis oil, and volatile organic compounds (VOCs) can be released in operation 150. For example, and as one skilled in the art will appreciate, the pyrolysis oil from the lignin can comprise light oil, such as, for example and without limitation, Catechol, methanol, acetic acid, water, and the like, and/or heavy oil, such as, for example and without limitation, phenolic compounds, and the like.

It is contemplated that the resultant high-purity lignin based carbon aerogels can be formed, for example and without limitation, as a monolithic structure, as a composite, as a thin film, as a granular powder, and the like.

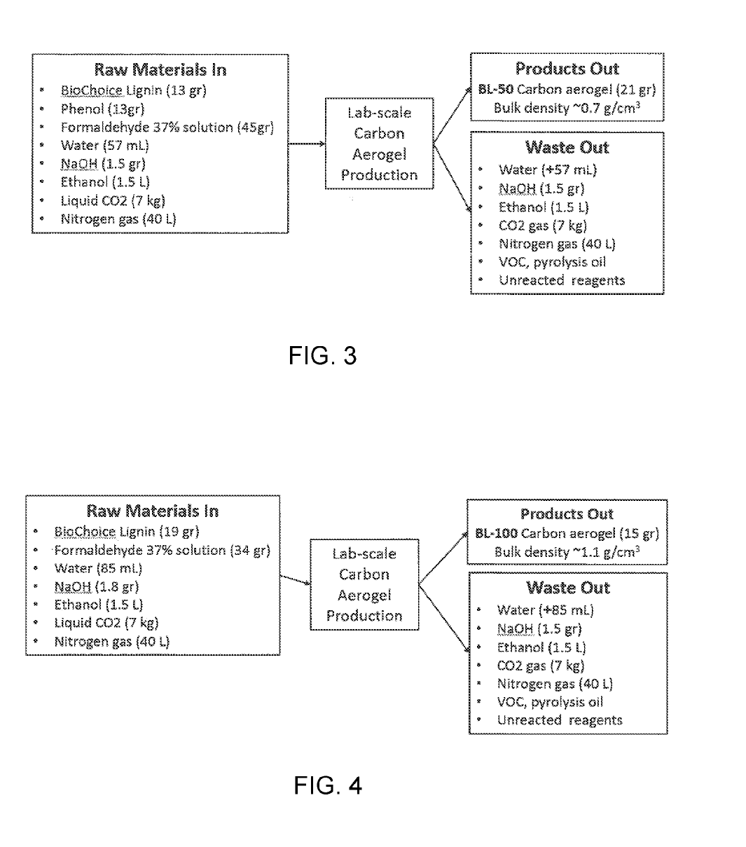

FIGS. 3 and 4 illustrate exemplary weight compositions of materials added in the method schematically illustrated in FIG. 2 to form an exemplary carbon aerogel having a bulk density of approximately 0.7 g/cm³ (BL-50), shown in FIG. 3, and an exemplary carbon aerogel having a bulk density of approximately 1.1 g/cm³ (BL-100), shown in FIG. 4. FIGS. 3 and 4 further exemplarily illustrate the waste materials that can be produced by the method schematically illustrated in FIG. 2 to form the respective BL-50 and BL-100 carbon aerogels.

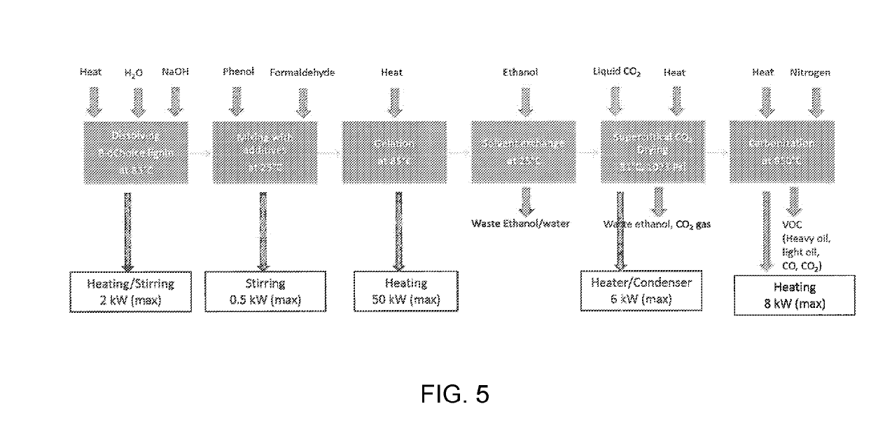

FIG. 5 illustrates the power consumption in the respective operational steps 110-160. The power consumption required for the generating the respective BL-50 and BL-100 carbon aerogels shown in FIGS. 3-4 is 66.5 kW per 21 gr carbon aerogel for a total of 3167 kW/kg for the BL-50 (FIG. 3) process and is 66.5 kW per 15 gr carbon aerogel for a total of 4433 kW/kg for the BL-100 (FIG. 4) process.

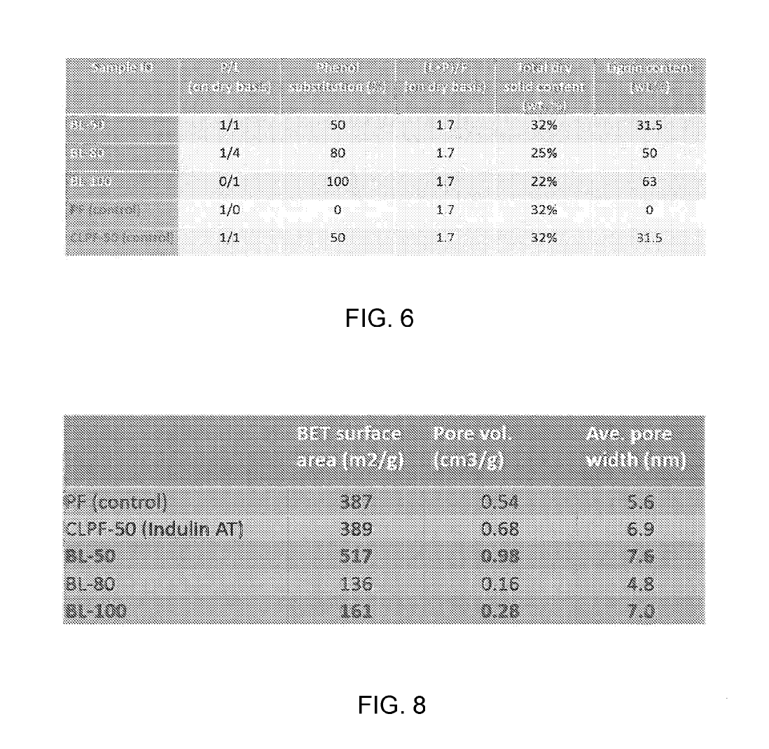

FIG. 6 shows experimental formulations for carbon aerogels produced using high-purity lignin (the BL samples) and control samples from phenol-formaldehyde (PF) and an additional control lignin source (Indulin AT) prepared under identical conditions using the method schematically illustrated in FIG. 2.

The high-purity lignin based carbon aerogels produced by the method schematically illustrated in FIG. 2 are porous, amorphous, nano-carbon materials that have a three-dimensional interconnected porous structure. It is contemplated that the average size and density of the pores in the formed high-purity lignin based carbon aerogels can be dimensioned on a nanometer scale.

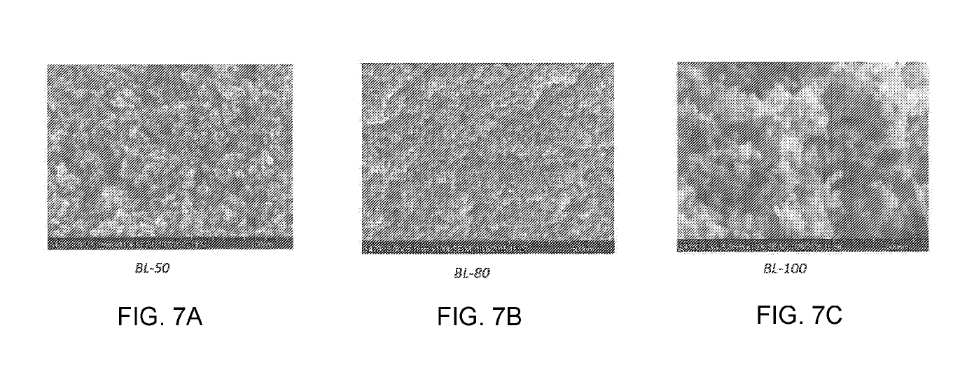

Referring to FIG. 7 and FIG. 8, the surface of the formed high-purity lignin based carbon aerogels is mainly composed of mesopores. The pore diameter of the formed high-purity lignin based carbon aerogels, can vary from about 2 nm to about 50 nm. For example, the average pore diameter of the formed high-purity lignin based carbon aerogels can be about 2 nm, about 3 nm, about 4 nm, about 5 nm, about 7.5 nm, about 10 nm, about 15 nm, about 25 nm, about 30 nm, about 35 nm, about 40 nm, about 45 nm, about 50 nm, or an average pore diameter between any two of these values. In some aspects, the high-purity lignin based carbon aerogels can have an average pore diameter of at least about 2 nm. Optionally, the high-purity lignin based carbon aerogels can have an average pore diameter of not more than about 50 nm. In some aspects, the high-purity lignin based carbon aerogels can have a pore diameter of about 5 nm to about 8 nm. It was observed that the average pore sizes are substantially comparable irrespective of lignin weight composition.

The surface area of the high-purity lignin based carbon aerogels can be determined by any known method, such as the Brunauer-Emmett-Teller (BET) method. As shown in the figures, the BET surface area of the high-purity lignin based carbon aerogels can vary from about 100 m²/g to about 600 m²/g. It is contemplated that the high-purity lignin based carbon aerogels can have a BET surface area of about 100 m²/g, about 150 m²/g, about 200 m²/g, about 300 m²/g, about 400 m²/g, about 500 m²/g, about 600 m²/g, or a BET surface area between any two of these values. It was observed that the surface area and pore volume decreased as the relative amount of the high-purity lignin content was increased.

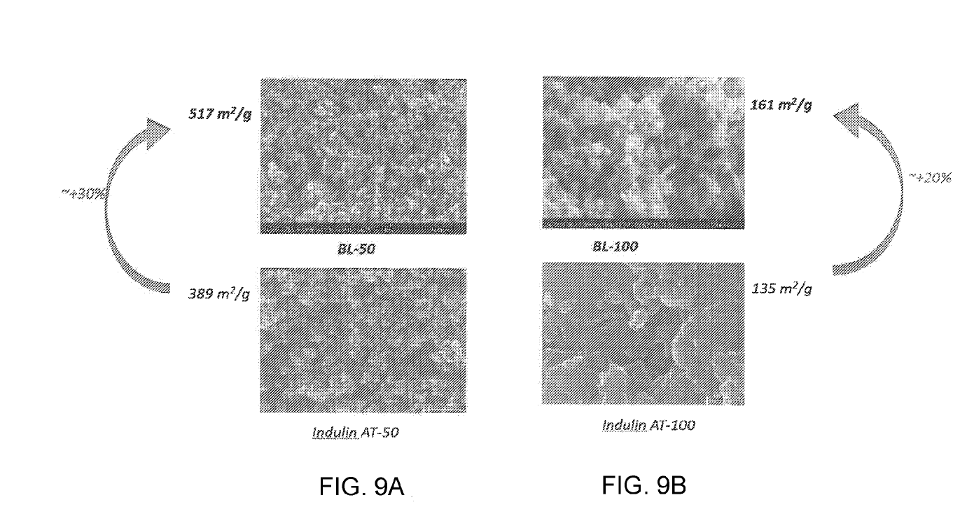

The bulk density of the high-purity lignin based carbon aerogels formed using the method schematically illustrated in FIG. 2 can also vary, for example, from about 0.60 g/cm³ to about 1.35 mg/cm³, and preferably from about 0.65 g/cm³ to about 1.25 mg/cm³. Optionally, the high-purity lignin based carbon aerogels have a bulk density of from about 0.70 g/cm³ to about 1.22 mg/cm³. Further, the bulk density of the formed high-purity lignin based carbon aerogel decreased at a 50% phenol substitution and increased with further percentage phenol substitution. As exemplarily shown in FIGS. 9A and 9B, the surface area/pore volume of the high-purity lignin based carbon aerogels is higher than the surface area/pore volume of the sample produced with the Indulin AT-100 lignin.

The volume shrinkage of the high-purity lignin based carbon aerogel product formed in the carbonization operation 160 is between about 73 to about 90%. It was experimentally shown that the relative volume shrinkage of the lignin based carbon aerogel product increased as the relative weight percent of the lignin content was increased. The char yield, which is typically defined as the percentage of solid material obtained at end of pyrolysis, of the carbon aerogel product formed in the carbonization operation 160 remained unchanged at between about 51 to about 54% irrespective of the weight percent of the lignin content.

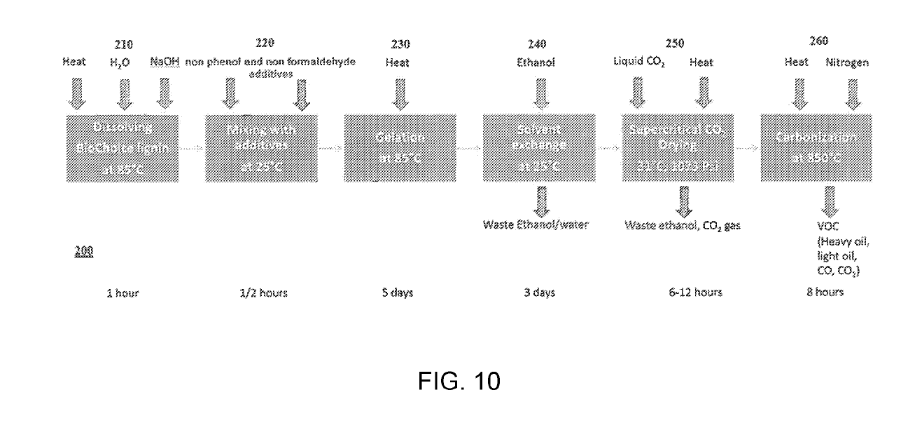

In an alternative embodiment, and referring to FIG. 10, a formaldehyde free carbon aerogel can be formed from the high purity lignin. In an optional embodiment, it is contemplated to form a formaldehyde free carbon aerogel that is also phenol-free. In FIG. 10, operations 210-260 are illustrated as being performed sequentially with operation 210 first and operation 260 last. For clarity, any temperature, dwell times, or pressure that are identical between the methodologies shown in FIGS. 2 and 10 are identified by similar descriptions.

At operation 210, the high-purity lignin can be dissolved in the solution of water and sodium hydroxide (NaOH) that subsequently heated to the desired first temperature and held at that first temperature for a desired first dwell time so that the high-purity lignin can naturally crosslink through free radical reactions that cause the lignin chains to cleave and then to reform new bonds.

In operation 220, at least one additive is added to the dissolved mixture exiting operation 210. It is contemplated that the at least one additive can comprise at least one of glyoxal, epichlorohydrin, and jeffamine. Optionally, it is contemplated that the at least one additive comprises at least two additive selected from the group comprising glyoxal, epichlorohydrin, and jeffamine. Further in this embodiment, it is contemplated that the at least one additive will not comprise phenol or formaldehyde. The resultant mixture formed in operation 220 can be held at the second temperature for the desired second dwell time.

Subsequently, in operation 230, the mixture exiting operation 220 can be held at a desired temperature for a desired dwell time to allow for gelation to occur. The desired temperature for operation 230 can be at least of at least about 60° C., preferably at least about 65° C., and most preferred about 70° C. It is optionally contemplated that the desired temperature for operation 230 can be between about 60° C. to about 80° C. The desired dwell time in operation 230 can be at least about 1 hour, preferably at least about 2 hours, and most preferred about 3 hours. In an alternative aspect, the preferred desired dwell time in operation 230 can be between about 1 hour to about 4 hours, and preferably between about 1 hour to about 3 hours.

In operation 240, at least one solvent can be added the formed hydrogel produced in operation 230 so that waste materials, which can comprise water and ethanol, can be removed. After adding the at least one solvent, the formed mixture in operation 240 can be processed at the desired fourth temperature for the desired fourth dwell time.

In operation 250, liquid carbon dioxide (CO₂) can be added to the product emerging from operation 240 to effect supercritical drying. In the course of this operation, the mixture in operation 250 can be held at the fifth temperature under the desired pressure for the desired fifth dwell time. Finally, in operation 260, nitrogen can be added to the mixture exiting operation 250 to allow for the slow pyrolysis of the mixture exiting operation 250, which carbonizes the formed product. In this operational step, the resultant mixture held at the desired sixth temperature for the desired sixth dwell time after the nitrogen is added.

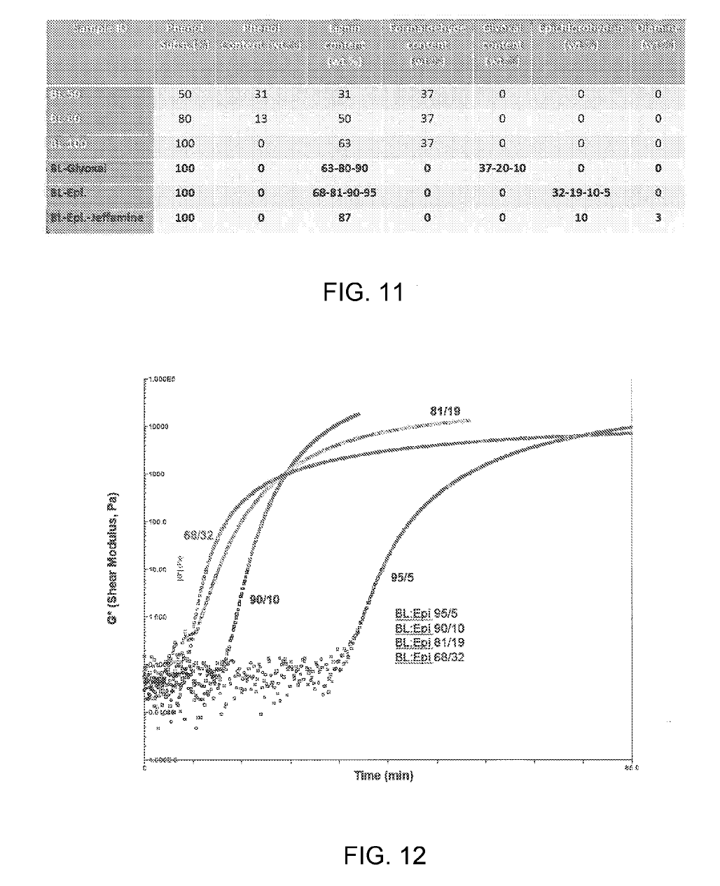

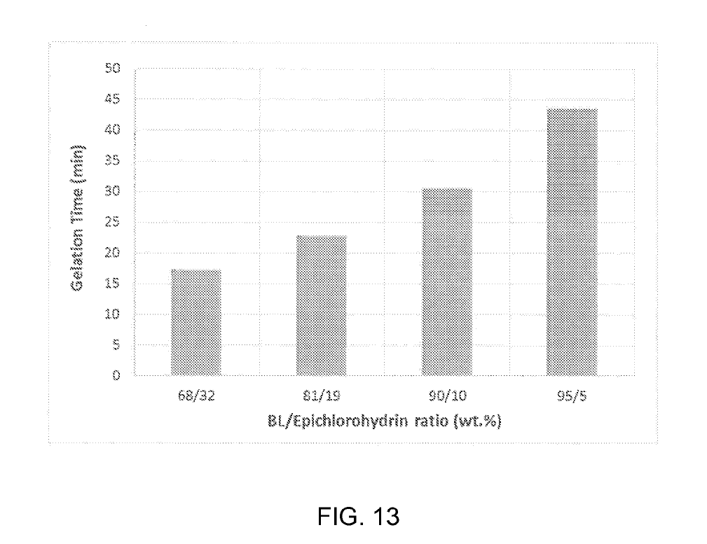

FIG. 11 illustrates experimental results for exemplary weight compositions of additive materials added in the method illustrated in FIG. 10 to form exemplary high purity lignin based carbon aerogels. FIG. 12 illustrates the change of shear modulus (G*) as the crosslinking reactions took place in the gelation process for the tested lignin to epichlorohydrin weight ratios. It is noted in the test results that the shear modulus onset point decreased as the additive level (the crosslinker content) increased in the tested relative lignin to epichlorohydrin weight ratios. FIG. 13 shows that the gelation time required in operation 230 can be decreased by increasing the level of the selected additive.

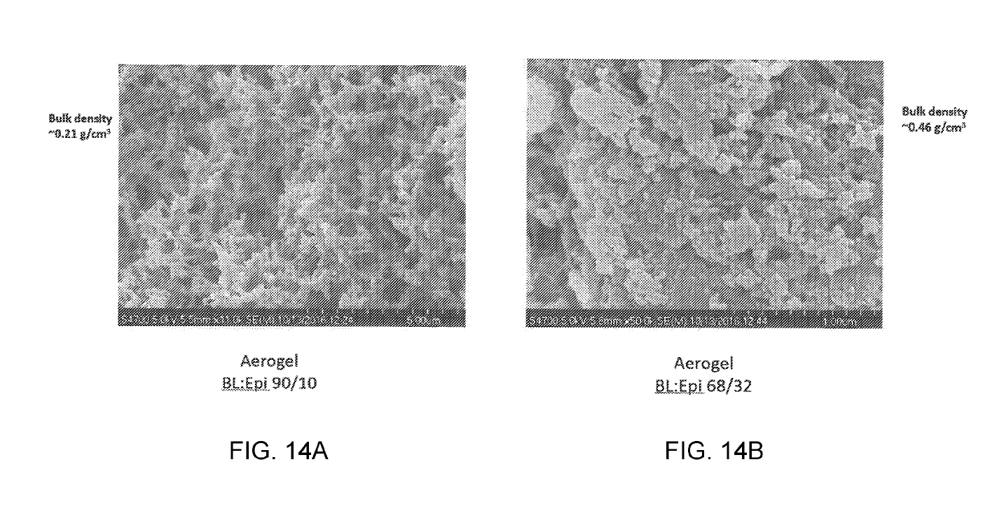

Further, as shown in the SEMS photographs illustrated in FIGS. 14A-14B, the relative bulk density of the formed carbon aerogel is higher for high purity lignin based carbon aerogels formed with an increased additive (crosslinker) weight content. As shown in FIG. 14A, a high purity lignin based carbon aerogel formed with a lignin to epichlorohydrin weight ratio of 90/10 had a bulk density of approximately 0.21 g/cm³ (BL:Epi 90/10) in comparison to, as shown in FIG. 14B, a high purity lignin based carbon aerogel formed with a lignin to epichlorohydrin weight ratio of 68/32 had a bulk density of approximately 0.46 g/cm³ (BL:Epi 68/32).

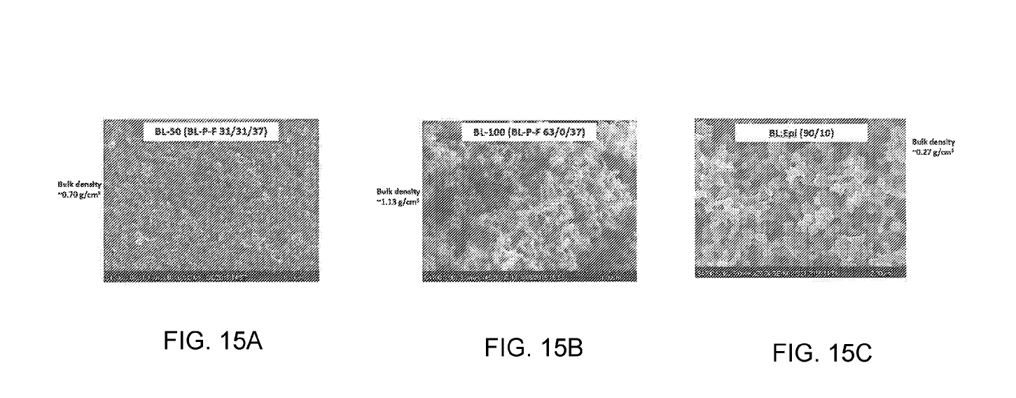

Referring now to FIGS. 15A-15C, the surface morphology of an exemplary high purity lignin based carbon aerogel formed by the method illustrated in FIG. 10 (BL:Epi 90/10) is compared to the surface morphologies of exemplary high purity lignin based carbon aerogels formed by the method schematically illustrated in FIG. 2 (BL-P-F 31/31/37 and BL-P-F 63/0/37). It is noted that the exemplary high purity lignin based carbon aerogels (BL-P-F 31/31/37 and BL-P-F 63/0/37) formed by the method schematically illustrated in FIG. 2 have higher bulk density (respectively approximately 0.7 g/cm³ (BL-50) and approximately 1.1 g/cm³ (BL-100)) than the bulk density of the exemplary high purity lignin based carbon aerogel (BL:Epi 90/10) produced by the method illustrated in FIG. 10. It was found that the exemplary high purity lignin based carbon aerogels formed by the method illustrated in FIG. 10 have a larger particle size, lower bulk density and more open space then comparable exemplary high purity lignin based carbon aerogels formed by the method schematically illustrated in FIG. 2.

The carbonization induced shrinkage of the high purity lignin based carbon aerogels formed in the method schematically illustrated in FIG. 10 is low. In one example, the change in the bulk density of the tested high purity lignin based carbon aerogel (BI:Epi 90/10) due to induced shrinkage was 0.06 g/cc.

It was noted that the gelation times were reduced for the high purity lignin based carbon aerogels formed in the method schematically illustrated in FIG. 10 that used both epichlorohydrin and jeffamine as additives. In the exemplary sample in which the weight percentage of lignin/epichlorohydrin/jeffamine was 87/10/3, the gelation time was reduced from approximately 30 minutes to approximately 18 minutes. In this aspect, both the gelation times and the bulk density of the formed high purity lignin based carbon aerogel increased as the weight percentage level of Jeffamine was increased in the formation of the high purity lignin based carbon aerogel.

It is also noteworthy that the formed high-purity lignin based carbon aerogels have improved surface area and pore volume properties, which can provide for improved electrochemical energy storage (supercapacitor) performance of the produced carbon aerogels relative to other industrial lignins. Both the gravimetric (F/g) and volumetric (F/cc) capacitance of high-purity lignin based carbon aerogels are demonstratively superior as compared to the control samples (phenol-formaldehyde based carbon aerogels and the Indulin AT lignin based carbon aerogels). Thus, it is contemplated that the formed high-purity lignin based carbon aerogels can be easily integrated into other materials, including materials for special applications such as electrode materials for supercapacitor cells, energy storage devices, catalysts and the like.

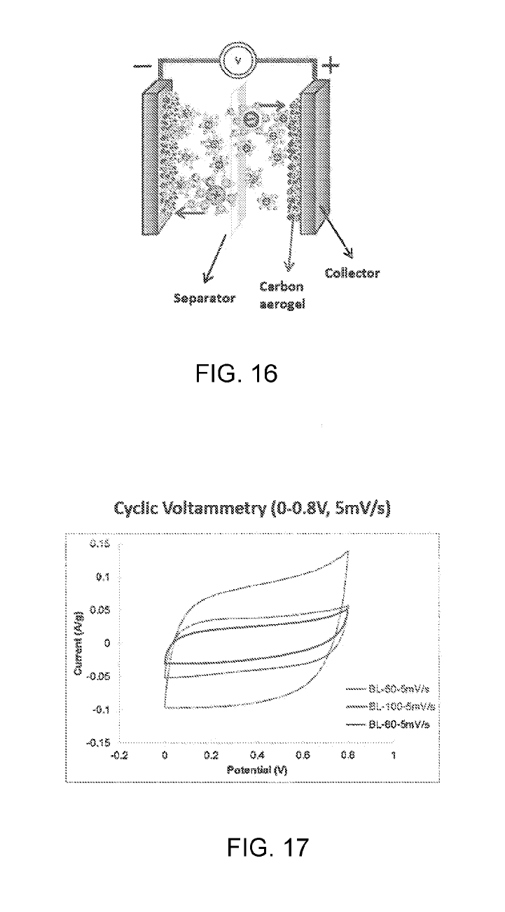

Referring to FIG. 16, supercapacitor cells can be formed with supercapacitor electrodes comprised of the high-purity lignin based carbon aerogels produced by the methods described herein. Optionally, it is contemplated that the superconductor electrodes can comprise high-purity lignin based carbon aerogel (in a powdered form), a polymer binder and, optionally, carbon black. In one exemplary and non-limiting example, the powdered high-purity lignin based carbon aerogel, polymer binder, and carbon black can be combined in a weight ratio of 80:10:10.

As shown in FIG. 16, a pair of opposed supercapacitor electrodes can be respectively coupled to a pair of opposed metal voltage collectors. It is contemplated that a porous insulating separator can be interposed between the pair of opposed supercapacitor electrodes and an appropriate electrolyte solution, such as, for example and without limitation, a sulfuric acid solution, can also be introduced between the pair of opposed supercapacitor electrodes to form the supercapacitor cells.

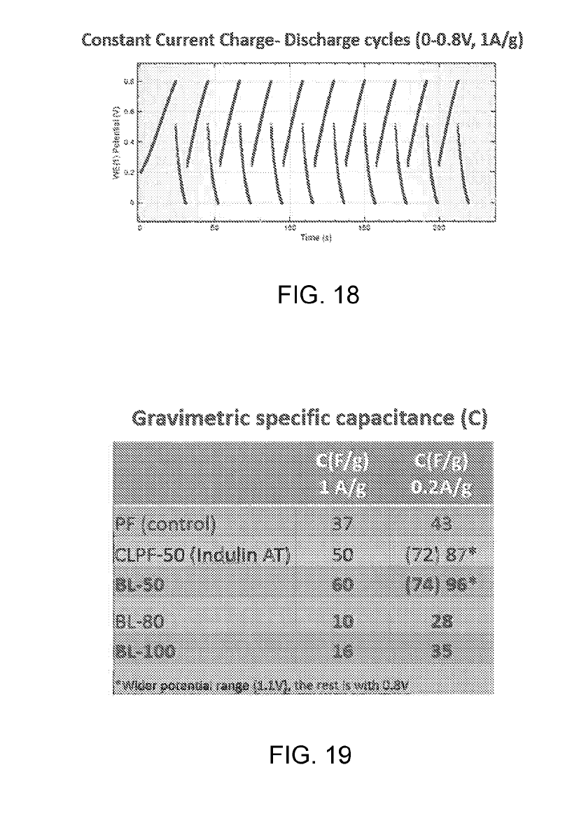

Referring to FIGS. 17-19, the supercapacitor cells formed with supercapacitor electrodes formed from the high-purity lignin based carbon aerogel, polymer binder, and carbon black in a weight ratio of 80:10:10 show promising capacitive behavior with quasi-rectangular CV curves, regular and triangular shape charge/discharge curves, and little to no decrease in capacitance after 800 charge/discharge cycles.

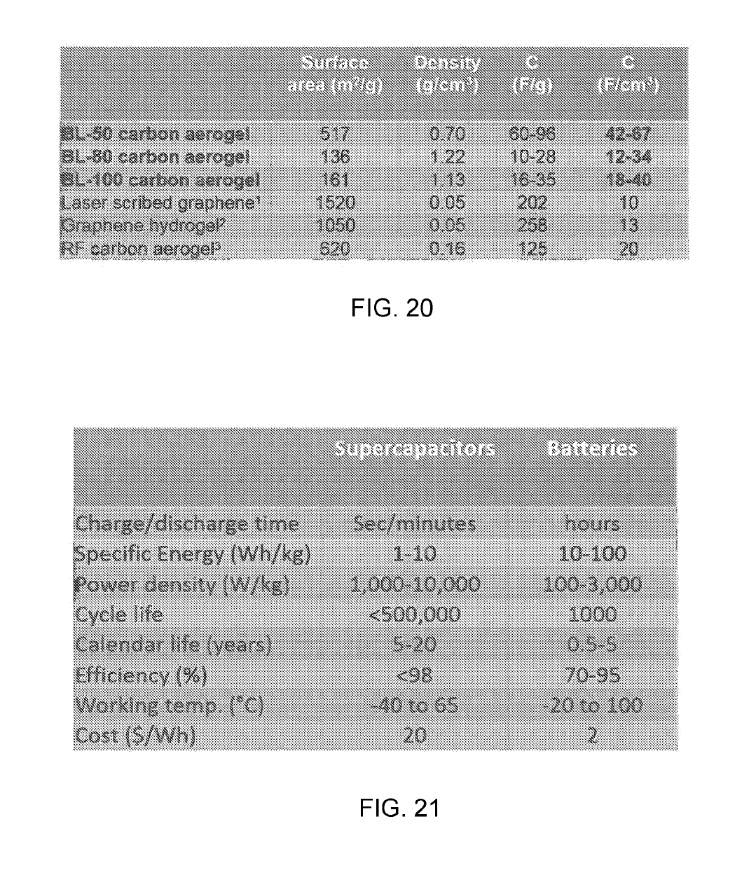

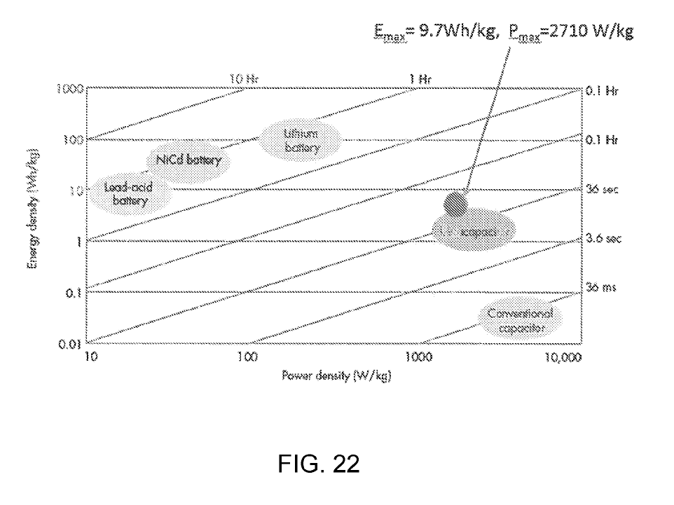

Referring to FIGS. 20 and 21, the supercapacitor electrodes formed from the high-purity lignin based carbon aerogel can provide improved volumetric capacitance performance. The highly porous nature of the high-purity lignin based carbon aerogel provides a high surface area value, which generates a high gravimetric capacitance (F/g).

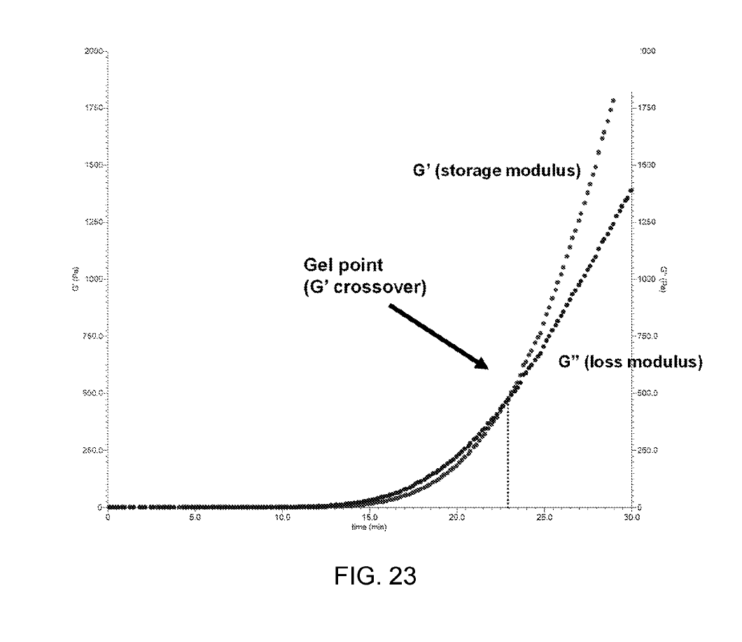

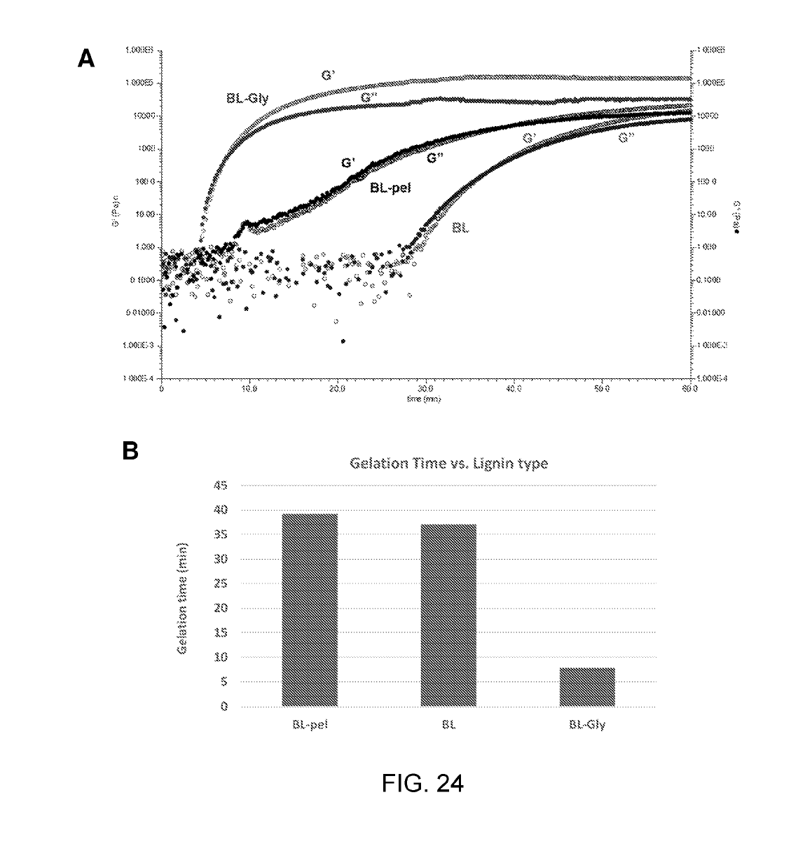

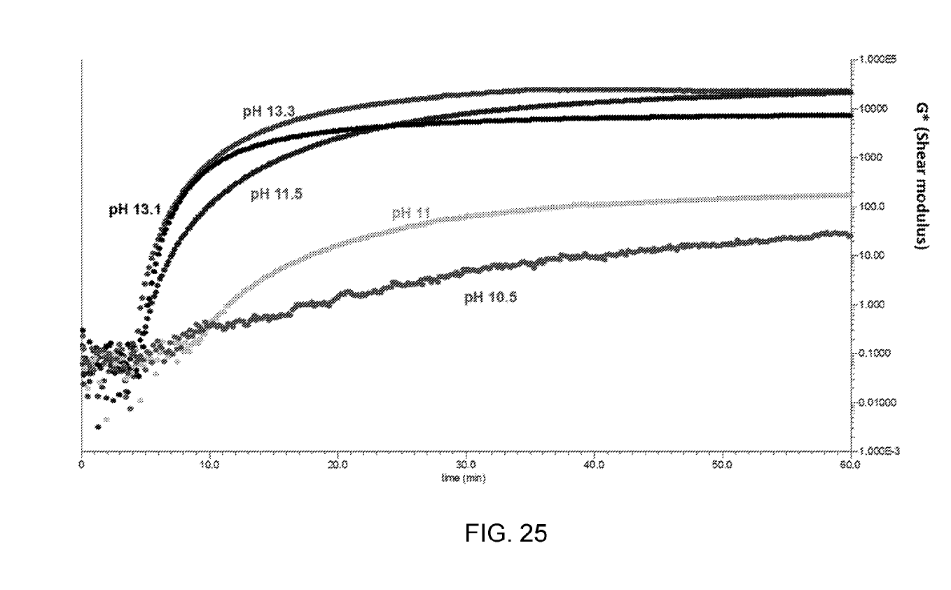

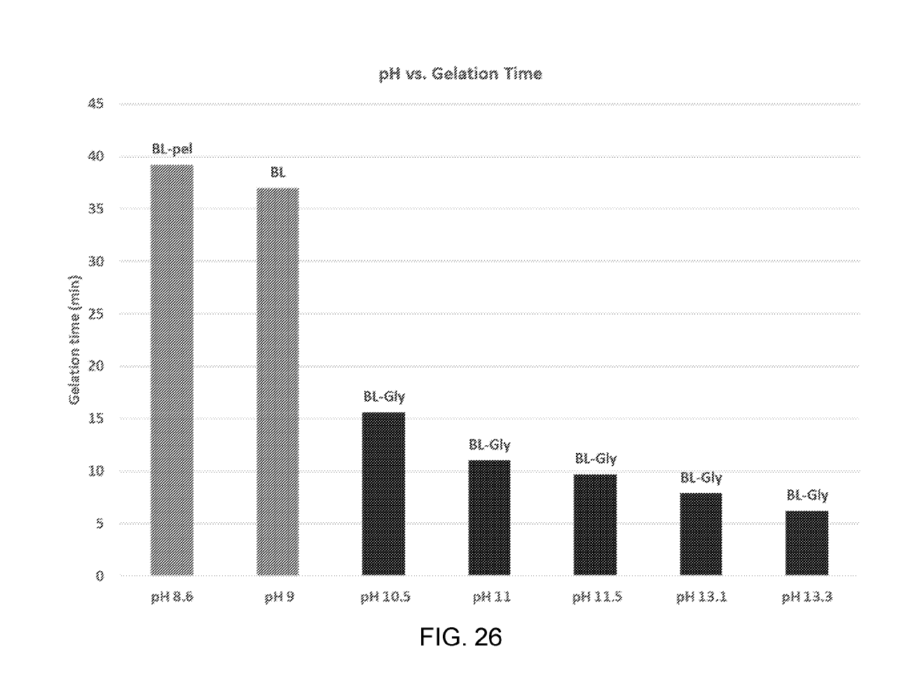

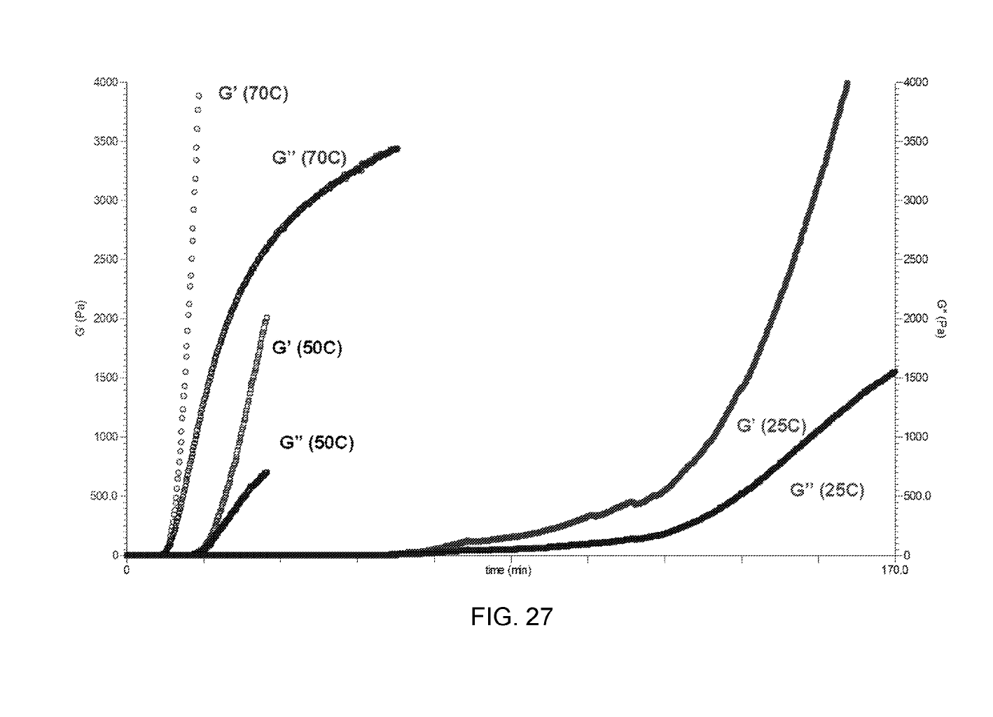

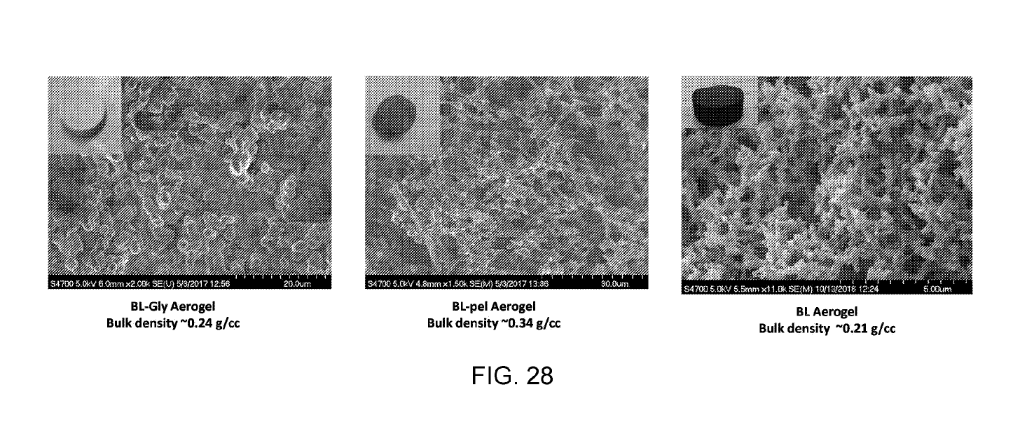

In certain examples, gelation of lignin aerogels with epichlorohydrin were characterized based on the type of lignin (e.g., BioChoice lignin (BL), Glyoxalated lignin (BL-Gly), Low water soluble lignin pellets (BL-pel), the reaction pH, and the reaction temperature. FIGS. 23 to 28 show some examples of these studies. FIG. 23 shows the results of gel formation of different lignin types with epichlorohdyrin at 70° C., the gel point determined with Rheometer. The gel point is defined as the point at which G′ becomes larger than G″ indicating that the fluid has transitioned from fluid flow like behavior to solid elastic behavior. The shear modulus (G*) increases as the crosslinking reactions take place. FIG. 24 shows an example of the effect of the type of lignin on gel formation with Epichlorohydrin at 70° C. using BioChoice lignin (BL) and Glyoxalated lignin (BL-Gly) as compared to Low water soluble lignin pellets (BL-pel) reacted with epichlorohydrin at 70° C. BL-Gly is more reactive towards epichlorohydrin>>faster gelation, lower gelation time. FIG. 25 shows the effect of reaction pH on gel formation. Gelation time is reduced as the pH increased. Higher pH results in higher shear modulus (G*)>>faster gelation and more crosslinking reactions took place. FIG. 26 shows the effect of reaction pH and lignin type on gelation time. Gelation time reduced as the pH increased. For the same NaOH molarity, BL and BL-pel water solutions gave lower pH values compared to BL-Gly. FIG. 27 shows the effect of reaction temperature on gelation time. Gel formation was faster as the reaction temperature increased (˜7 min @70° C., ˜13 min @50° C., ˜50 min @25° C.). All types of lignins formed gels with epichlorohydrin at room temperature (1 h or more). FIG. 28 shows micrographs illustrating the surface morphology of lignin aerogels with epichlorohydrin. The micrographs are shown with insets of digital images of aerogels. The lignin aerogels comprises a Lignin:Epi ratio 90:10. The micrographs show that aerogels with BL-Gly and lignin pellets are composed of larger aggregates and macropores.

It should be emphasized that the above-described embodiments are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual embodiments or combinations of elements or steps are intended to be supported by the present disclosure. Moreover, although specific terms are employed herein, as well as in the claims which follow, they are used only in a generic and descriptive sense, and not for the purposes of limiting the described invention, nor the claims which follow.

1. A method of making lignin based aerogel and carbon aerogel, comprising the steps of:
combining a lignin with water and sodium hydroxide to form a first mixture and holding the first mixture to a first temperature for a first dwell time (lignin dissolving step);
combining at least one additive to the first mixture to form a second mixture, and holding the second mixture to a second temperature for a second dwell time;
heating the second mixture to a third temperature for a third dwell time to form a gelated mixture (gelation step);
combining the gelated mixture and at least one solvent to form a fourth mixture and holding the fourth mixture to a fourth temperature for a fourth dwell time (solvent exchange step);
drying the fourth mixture to form a fifth mixture and holding the fifth mixture to a fifth temperature for a fifth dwell time (drying step); and
carbonizing the fifth mixture and heating the mixture to a sixth temperature for a sixth dwell time to carbonize and produce the high-purity lignin based carbon aerogel.

2. The method of claim 1, wherein the lignin has an impurity level of 0.02 to 5.00 weight percent.

3. The method of claim 1, wherein the lignin has a sulfur content of less than 5 weight percent.

4. The method of claim 1, wherein the lignin is a hardwood lignin.

5. The method of claim 1, wherein the lignin is a softwood lignin.

6. The method of claim 1, wherein the first temperature is from 75 to 95° C., and the first dwell time is from 30 to 90 minutes.

7. The method of claim 1, wherein the second temperature is from 15 to 30° C., and the second dwell time is from 20 to 40 minutes.

8. The method of claim 1, wherein the third temperature is from 75 to 95° C., and the third dwell time is from 3 to 6 days.

9. The method of claim 1, wherein the fourth temperature is from 13 to 30° C., and the fourth dwell time is from 1 to 4 days.

10. The method of claim 1, wherein the fifth temperature is from 25 to 35° C., and the fifth dwell time is from 4 to 15 hours.

11. The method of claim 1, wherein the fourth mixture is subjected to a pressure from 750 to 1500 psi during the drying step.

12. The method of claim 1, wherein the sixth temperature is between 800 and 900° C., and the sixth dwell time is from 6 to 10 hours.

13. A lignin-based carbon aerogel produced by the method of claim 1.

14. A supercapacitor electrode comprising the lignin-based carbon aerogel of claim 13.
